(19) United States
(12) Patent Application Publication
(10) Pub. No.: US 2026/0016826 A1
(43) Pub. Date: Jan. 15, 2026

(54) System and Method for Constructing Underground Multi-Robot Collaborative Digital Twin Scene Model

(71) Applicant: China University of Mining and Technology, Xuzhou (CN)

(72) Inventors: Menggang LI, Xuzhou (CN); Kun HU, Xuzhou (CN); Gongbo ZHOU, Xuzhou (CN); Eryi HU, Xuzhou (CN); Chaoquan TANG, Xuzhou (CN); Ping ZHOU, Xuzhou (CN); Yue LI, Xuzhou (CN); Zhiwen JIN, Xuzhou (CN)

(73) Assignee: China University of Mining and Technology, Xuzhou (CN)

(21) Appl. No.: 18/959,697

(22) Filed: Nov. 26, 2024

(30) Foreign Application Priority Data
Jul. 11, 2024 (CN) 202410927182.0

(51) Int. Cl. G05D 1/246; G05D 1/622; G05D 1/69; G05D 105/80; G05D 107/70; G05D 111/10; G05D 111/30; G05D 111/50; G05D 111/63; G06T 17/20

(52) U.S. Cl. CPC G05D 1/246; G05D 1/622; G05D 1/69; G06T 17/20; G05D 2105/87; G05D 2107/73; G05D 2111/17; G05D 2111/32; G05D 2111/52; G05D 2111/65

(57) ABSTRACT

A system and method for constructing a collaborative digital twin scene model for multiple underground robots belongs to the technical field of digital twin modeling for mines. The system includes a master robot i and sub-robots, both of which are connected to a main control module. The master robot i is equipped with a visualization module, a perception module, a computation module, and a communication module. The system and method for constructing a collaborative digital twin scene model for multiple underground robots is adopted to accurately measure and model the geometric and physical structures of tunnels. It enables the construction of a colored mesh map, which is further imported into Unity3D. Through this process, the pose transmission of the master robot i and the sub-robots within the UWB ranging range is realized, and the local colored mesh maps are stitched into a global colored mesh map.

### CROSS REFERENCE TO THE RELATED APPLICATIONS

This application is based upon and claims priority to Chinese Patent Application No. 202410927182.0, filed on Jul. 11, 2024, the entire contents of which are incorporated herein by reference.

### TECHNICAL FIELD

The invention relates to the field of mine multi-robot collaborative mapping technology, specifically to a system and method for constructing an underground multi-robot collaborative digital twin scene model.

### BACKGROUND

Digital twin technology can create a virtual replica of the underground coal mine scene, enabling simulation, risk prediction, and remote control. Currently, geological and tunnel digital twin modeling in fully mechanized mining faces use manual pre-modeling methods, which are inefficient and difficult to update. This only allows simulation mapping of preset 3D models and cannot achieve real-time modeling data-driven real-world mapping, failing to meet the needs of complex and variable underground mining environments. Traditional modeling methods for coal mines involve using SolidWorks to model tunnel scenes, then rendering the model through texture baking. This process takes from one month to several months, is unable to update in real-time, and involves substantial labor. Moreover, the harsh conditions in underground coal mines, such as confined spaces, complex terrain, low lighting, and moisture, can degrade sensors, leading to inaccuracies in mapping and localization, and preventing the provision of accurate prior maps for digital twins. Therefore, rapidly acquiring underground coal mine environment information and building a high-precision 3D color scene model is an urgent problem to be solved for constructing digital twin scene maps.

Currently, constructing digital twin scene models for coal mines using robots has not been realized. Research on single-robot technology, such as environment perception and motion control, is already very mature. However, single robots face shortcomings when performing distributed mapping tasks in complex coal mine environments, such as low mapping efficiency, limited mapping range, and poor endurance. Multi-robot systems, which use multiple robots with similar or heterogeneous structures to complete specific tasks, have higher execution capabilities and collaboration capabilities, making them suitable for complex and changing environments. Compared to single-robot systems, multi-robot systems offer higher work efficiency, broader vision, and greater flexibility and robustness. Utilizing multi-robot collaboration to construct large-scale underground coal mine digital twin models and achieve dynamic updates is of significant research and practical value for improving digital twin scene modeling efficiency and advancing coal mine digital twin technology.

### SUMMARY

The invention aims to provide a system and method for constructing an underground multi-robot collaborative digital twin scene model, achieving precise measurement and modeling of tunnel geometrical and physical structures, constructing a colored mesh map, and further importing the colored mesh map into Unity3D. This system facilitates pose transmission between the master robot i and sub-robots within the UWB distance measurement range, ultimately stitching local colored mesh maps into a global colored mesh map and constructing a large-scale underground coal mine digital twin scene model.

To achieve the above objectives, the invention provides a system for constructing an underground multi-robot collaborative digital twin scene model, including a master robot i and sub-robots. The master robot i and the sub-robots are both connected to a main control module. The master robot i is equipped with a visualization module, a perception module, a computation module, and a communication module:

Visualization Module: Used to display the digital twin scene model, equipment models, monitoring robot movement status, battery levels, wear conditions, and external environment temperature and humidity.

Perception Module: Used for the robot to perceive features, temperature, and humidity in the underground coal mine.

Computation Module: Used to process data for single/multi-robot movement, localization, mapping, exploration, and path planning in the underground environment.

Communication Module: Used for communication between multiple robots underground and between the underground and the surface.

Preferably, the perception module includes intrinsically safe LiDAR, intrinsically safe cameras, ultra-wideband (UWB) distance measurement units, and inertial measurement units. The computation module includes localization and mapping units, mesh reconstruction units, planning and control units, and multi-robot collaboration units. Multi-robot collaborative unit is connected to the sub-robots, including sub-robot j and sub-robot r. The master robot i and the sub-robots have the same structure, including a tracked chassis. The top of the tracked chassis is equipped with an explosion-proof box containing the inertial measurement unit and computation module. The top of the explosion-proof box has a fixed bracket. One side of the fixed bracket is equipped with a UWB distance measurement unit, and one side of the UWB distance measurement unit has an intrinsically safe camera. Next to the intrinsically safe camera is a WiFi base station with Mesh nodes. On one side of the WiFi base station are two intrinsically safe LiDARs, and between the two LiDARs is the visualization module.

Method for Constructing an Underground Multi-Robot Collaborative Digital Twin Scene Model, the method includes the following steps:

S1. Sensor Module Installation: Install the sensor module on the robot based on the length and cross-section of the tunnel.

S2. Intrinsic and Extrinsic Parameters Calibration: Obtain distortion correction parameters for intrinsically safe LiDAR, intrinsic parameters for intrinsically safe cameras, bias for the inertial measurement unit, and correction factors for the ultra-wideband (UWB) distance measurement units. Calculate the extrinsic transformation between the intrinsically safe LiDAR and the inertial measurement unit, the visual camera and the inertial measurement unit, and between the UWB mobile nodes and UWB anchor nodes.

S3. Coordinate System Alignment and Time Synchronization: Connect the sensor module to the computation module via a USB port to complete coordinate system alignment and time synchronization for the intrinsically safe LiDAR, intrinsically safe camera, and UWB distance measurement units.

S4. Color Point Cloud Construction: Use the intrinsically safe LiDAR, intrinsically safe camera, inertial measurement unit, and UWB mobile nodes to complete high-precision color point cloud construction and calculate the six-degree-of-freedom pose of the robot based on graph optimization methods.

S5. Color Mesh Map Construction: Based on the color point cloud constructed in Step 4, combine vertex retrieval, point projection for dimensionality reduction, 2D Delaunay triangulation, and voxel grid division to create a color mesh map.

S6. Multi-Robot Collaborative Exploration and Mapping: Use UWB anchor nodes as the information hub, integrate the optimal state estimates calculated in Step 4 and the color mesh map constructed in Step 5 to achieve multi-robot collaborative formation control, path planning, and map fusion.

S7. Global Descriptor Construction: Construct a triangular descriptor, project the color point cloud onto a plane boundary, and extract key points. Adjacent key points form triangular descriptors, which are invariant to rotation and translation while maintaining high distinguishability.

S8. Data Publishing: The main robot i processes the original colored point cloud calculated in S4.10 and the updated colored mesh map obtained in S5.6 through the computing module, and publishes odometry data at the sampling rate of the inertial measurement unit.

S9. Digital Twin Scene Model Construction: Import the global color mesh map from Step 5.6 into the main control module. The main control module uses Unity3D to process and analyze the color mesh map to construct the digital twin scene model of the underground coal mine.

S10. Digital Twin Scene Model Update: During the back-and-forth modeling process of the robot swarm in the tunnel, use the global descriptors constructed in Step 7 for area detection. If the original descriptor for a certain position in the tunnel does not match the new descriptor from the updated model, mark the scene as an update area. The main control module then directs the robots to remap and updates the local color mesh map to the global color mesh map to complete the digital twin scene update.

Preferably, the Color Point Cloud Construction in step S4 includes the following steps:

S4.1. Data Collection: The main control module remotely controls the master robot i via WiFi, and the master robot i uses Mesh nodes to control sub-robots for data collection in the tunnel.

S4.2. Robot Motion Model Construction: Construct the robot's motion model.

S4.3. State Propagation: Discretize the motion model using error-state iterative extended kalman filter to build motion propagation equations and covariance matrices.

S4.4. Sensor Observation Model Construction: Calculate distances between mobile and anchor UWB nodes, build UWB distance and position observation equations, measure distances by calculating the time interval between emitted and received waves. Extract LiDAR feature points and build LiDAR point-plane, point-line, and line-line observations. Compute RGB information and pixel inverse depth of feature points, and build visual observations by minimizing photometric errors between observed map points and measured colors in the current image. Calculate angular velocity and acceleration of the inertial measurement unit to build IMU observations.

S4.5. Factor Graph Optimization Model Construction: The factor graph consists of variable nodes representing system states and four types of factor nodes representing measurement constraints. The five types of factor nodes provide different measurement constraints for state estimation. The system's backend optimization module uses these factors to build a multi-sensor factor graph and obtains optimal state estimation parameters through incremental smoothing optimization.

S4.6. LiDAR-Inertial Odometry Subsystem Construction: Based on the factor graph optimization model from Step 5, integrate raw point cloud and IMU data collected in Step 1 to perform state propagation. Minimize residuals between LiDAR feature points and planes to estimate system states, then add the estimated states to the global map as map points and mark the voxel corresponding to the LiDAR feature points as activated or deactivated.

S4.7. Visual-Inertial Odometry Subsystem Construction: Use frame-to-frame optical flow to track map points, estimate system states using the factor graph optimization model, and further optimize state estimation by minimizing photometric errors between tracked map points and the map.

S4.8. Factor Graph Optimization: After constructing the factor graph, solve for the optimal system states to ensure all edges in the factor graph achieve optimality, resulting in the system's optimal state parameters.

S4.9. Global Map Texture Rendering: After updating the visual-inertial odometry subsystem in S4.7, obtain precise poses for the current frame and execute rendering to update the colors of map points.

S4.10. Color Point Cloud Map Construction: After texture rendering in Step 9, update the tracked map points set. Project each point in the tracked map points set onto the current image and construct the color point cloud using the globally textured map obtained in Step 9. Complete the optimal system state estimation in Step 8.

Preferably, the Color Mesh Map Construction in step S5 includes the following steps:

S5.1. Color Point Cloud Map Import: Synchronize the raw color point cloud constructed in Step 4.10 into the mesh reconstruction unit of the computation module.

S5.2. Point Cloud Preprocessing: Filter, downsample, and remove noise from the raw color point cloud obtained in Step 5.1.

S5.3. Voxel-Based Vertex Retrieval and Expansion: Use hierarchical voxels to subdivide the raw color point cloud into many regions, retrieve vertices for grid division with newly added points, and perform 3D point cloud dilation to add mesh vertices and eliminate gaps between voxels, obtaining higher quality triangular meshes.

S5.4. Projection and Dimensionality Reduction: Project the 3D vertices retrieved in Step 5.3 onto a 2D plane to obtain the dimensionality-reduced point cloud.

S5.5. 2D Delaunay Triangulation: Triangulate the dimensionality-reduced point cloud into uneven triangular meshes, resulting in Delaunay triangulated triangular facets.

$5.6. Color Mesh Map Construction: Update triangular facets through voxel grid division operations and new triangular faces constructed from 2D Delaunay triangulation, progressively merging the mesh map into the voxel structure currently stored in the map.

Preferably, the multi-robot collaborative exploration and mapping in step S6 includes the following steps:

S6.1, Multi-Robot Deployment: Deploy the master robot i, sub-robot j, and sub-robot r to specified positions in the tunnel. Complete the installation of the perception module, calibration of intrinsic and extrinsic parameters, coordinate system alignment, and time synchronization according to steps S5.1 to S5.3. Also, synchronize the computation module and ensure consistent communication frequencies for wireless Mesh nodes.

S6.2, Multi-Robot Collaborative Path Planning: The master robot i uses an A*-based global path planning algorithm to search for a globally optimal path from the starting point to the target point based on its positioning information and map information obtained in S4.8 and S4.10. The master robot i then uses a DWA-based local path planning algorithm to adjust the poses of the sub-robots j and r by calculating their distances to relative obstacles.

S6.3, Multi-Robot Formation Control and Obstacle Avoidance: Construct a following formation movement model for the multi-robot system. The master robot i performs global and local path planning to achieve autonomous navigation, while the sub-robots j and r follow the master robot i and measure their distances to relative obstacles.

S6.4, Multi-Robot UWB Distance Measurement and Data Exchange: When multiple robots enter the distance measurement range of a UWB anchor node, they use UWB to measure distances and exchange the current poses of the master robot i and the sub-robots as well as the anchor positions.

S6.5, Multi-Robot Color Mesh Map Fusion: During map construction, each robot builds a local map with its starting point as the map origin based on its own mapping algorithm. The local maps are then fused and stitched together based on coordinate system transformations between local maps.

Preferably, the method for relative pose transformation of multiple robots in S6.4 is as follows:

In the presence of common anchors, robots directly estimate transformations between robots upon convergence. Robots only need to send their current positions and anchor positions when measuring distances to neighboring robots. After receiving this information, robots calculate the transformation matrix between themselves and the sender. Once the transformation matrix is correctly estimated, all information received from neighboring robots is correctly placed in the robot's coordinate system. For the master robot i and sub-robot j, the transformation matrix from the master robot i to sub-robot j is denoted as

$${T}_{i}^{j} = [ {R}_{i}^{j} , {t}_{i}^{j} ] ,$$

where

$${R}_{i}^{j}$$

is a 3×3 matrix representing rotation, and

$${t}_{i}^{j}$$

is a 3×1 vector representing translation. Using an accelerometer and gyroscope, determine the gravity direction and define the same z-axis for all robots. When creating the coordinate system, align the z-axis opposite to the gravity direction. Estimate the yaw angle θ and tranlastion vector

$${t}_{i}^{j}$$

between the two coordinate systems. The transformation matrix

$${T}_{i}^{j}$$

includes:

$${R}_{i}^{j} = [ \begin{matrix}cos ( θ ) & - sin ( θ ) & 0 \\ sin ( θ ) & cos ( θ ) & 0 \\ 0 & 0 & 1\end{matrix} ] , {t}_{i}^{j} = [ \begin{matrix}{t}_{x} \\ {t}_{y} \\ {t}_{z}\end{matrix} ]$$

Using the anchor positions of the two robots, estimate the projection of the difference vector between the master robot i and sub-robot j onto the z-axis, denoted as

$${t}_{z} = ( {P}_{A}^{jw} - {P}_{A}^{iw} ) z .$$

The three parameters (θ, tₓ, t_{y}) to be estimaed can be solved as follows:

S6.4.1, Exchange of Robot and Anchor Node Positions: Assume that the master robot i and sub-robot j move independently in a 2D space. Both robots have their own coordinate systems oᵢxᵢyᵢ and oⱼxⱼyⱼ, initial anchor A positions, and track their own trajectories in their respective coordinate systems. When the master robot i passes point B and the sub-robot j passes point C, they enter the communication range and obtain a bidirectional distance measurement d₁. Additionally, they exchange their current positions and anchor A positions in their respective coordinate systems oᵢxᵢyᵢ and oⱼxⱼyⱼ, obtaining

$${p}_{B}^{i} , {p}_{A}^{i} , {p}_{A}^{j} , {p}_{C}^{j} ,$$

where

$${p}_{B}^{i} , {p}_{A}^{i}$$

are the positions of points A and B in the coordinate system of the master robot i, and

$${p}_{A}^{j} , {p}_{C}^{j}$$

are the positions of points A and C in the coordinate system of the sub-robot j.

S6.4.2, Solving Sub-Robot Position C in the Master Robot's Coordinate System: From the perspective of the master robot i, when it receives the position of anchor A and the current position of sub-robot j's point C in the coordinate system oⱼxⱼyⱼ , i.e.,

$${p}_{A}^{i} , {p}_{C}^{j} ,$$

it knows that the origin of oⱼxⱼyⱼ must be located on a circle III centered at A with radius |AOⱼ|. Furthermore, the master robot i calculates |AC| to find that sub-robot j's position C must be located on a circle II centered at A with radius |AC|. The distance between points B and C is measured as d₁, and point C must also be located on a circle I centered at B with radius d₁. By solving the following equations:

$$\{ \begin{matrix}{d}_{1} = ‖ {P}_{B}^{i} - {P}_{C}^{i} ‖ \\ \vert AC \vert = ‖ {P}_{A}^{j} - {P}_{C}^{j} ‖ \\ \vert AC \vert = ‖ {P}_{A}^{i} - {P}_{C}^{i} ‖\end{matrix}$$

obtain the position of point C in the coordinate system of the master robot i.

S6.4.3, Solving Master Robot Position B in the Sub-Robot's Coordinate System: When the sub-robot j receives the position of anchor A and the current position of the master robot i's point B in the coordinate system, i.e.,

$${P}_{A}^{j} , {P}_{B}^{i} ,$$

it knows that the origin of oᵢxᵢyᵢ must be located on a circle centered at A with radius |AOᵢ|. Additionally, the sub-robot j calculates |AB| to find that the master robot i's position B must be located on a circle centered at A with radius |AB|. The distance between points B and C is measured as d₁, and point B must also be located on a circle centered at C with radius d₁. By solving the following equations:

$$\{ \begin{matrix}{d}_{1} = ‖ {P}_{B}^{j} - {P}_{C}^{j} ‖ \\ \vert AB \vert = ‖ {P}_{A}^{i} - {P}_{B}^{i} ‖ \\ \vert AB \vert = ‖ {P}_{A}^{j} - {P}_{B}^{j} ‖\end{matrix}$$

obtain the position of point B in the coordinate system of the sub-robot j.

S6.4.4, Solving Coordinates of Points D and E in the Sub-Robot and Master Robot Systems: When the master robot i is at point B and sub-robot j is at its position in the coordinate system of the master robot i, to further determine the positions of sub-robot j and master robot i in each other's coordinate systems, perform additional measurements between two subsequent points D and E. Repeat steps S6.4.2 and S6.4.3 to solve the following equations:

$$\{ \begin{matrix}{d}_{2} = ‖ {P}_{D}^{j} - {P}_{E}^{j} ‖ \\ \vert AD \vert = ‖ {P}_{A}^{i} - {P}_{D}^{i} ‖ \\ \vert AD \vert = ‖ {P}_{A}^{j} - {P}_{D}^{j} ‖\end{matrix} , \{ \begin{matrix}{d}_{2} = ‖ {P}_{D}^{i} - {P}_{E}^{i} ‖ \\ \vert AE \vert = ‖ {P}_{A}^{i} - {P}_{E}^{i} ‖ \\ \vert AE \vert = ‖ {P}_{A}^{j} - {P}_{E}^{j} ‖\end{matrix}$$

obtain the positions of points D in the coordinate system of the sub-robot j and E in the coordinate system of the master robot i.

S6.4.5, Robot Pose Calculation: Using the results obtained from steps S6.4.2 to S6.4.4, including the positions of points B in the coordinate system of the sub-robot j, C in the coordinate system of the master robot i, D in the coordinate system of the sub-robot j, and E in the coordinate system of the master robot i, calculate the translation and rotation from the master robot i to sub-robot j as follows:

$$\{ \begin{matrix}{P}_{A}^{j} = {T}_{i}^{j} \cdot {P}_{A}^{i} \\ {d}_{1} = ‖ {P}_{B}^{j} - {T}_{i}^{j} \cdot {P}_{C}^{i} ‖ \\ {d}_{2} = ‖ {P}_{D}^{j} - {T}_{i}^{j} \cdot {P}_{E}^{i} ‖\end{matrix}$$

Preferably, in S7, the triangular descriptor is extracted within the point cloud keyframe and consists of a global descriptor composed of three key point encodings. It can describe the relative distribution of key points within the keyframe. The triangular descriptor encodes any three key points in the scene using a triangle, where the shape of the triangle is uniquely determined by its side lengths or angles. Compared to the local descriptors around key points, the shape of the triangle is invariant to rotation and translation. After constructing the triangular descriptor, location recognition is achieved by matching the side lengths of descriptors between point clouds. The correspondences obtained from descriptor matching are further used for geometric verification.

Preferably, in S8, the specific operation is: Process the data of color point clouds and color mesh point clouds in parallel. After generating the color point cloud, continuously feed it into the mesh reconstruction unit for processing, ultimately generating a color mesh map online. Implement parallel processing for multi-robot pose estimation and multi-robot map fusion. During the multi-robot collaborative mapping process in the mine, sub-robot j continuously transmits local maps and pose results to the master robot i's computation module, which in turn parallelly optimizes the optimal poses of the robot group and fuses the local maps between sub-robot j and the master robot i.

Accordingly, the present invention adopts the above-mentioned system and method for constructing a digital twin scene model of a multi-robot collaboration in underground tunnels, and has the following beneficial effects:

(1) By constructing a multi-robot collaborative digital twin scene construction system for underground tunnels, high-precision colored point cloud mapping of the tunnels can be achieved during the round-trip planning and exploration process, allowing for accurate measurement and modeling of the tunnel's geometric and physical structure.

(2) By constructing the underground multi-robot collaborative digital twin scene construction system, operations such as vertex retrieval, vertex projection dimensionality reduction, 2D Delaunay triangulation, and voxel grid division are utilized to construct a colored mesh map. This colored mesh map is further imported into Unity3D to ultimately achieve the construction of a digital twin scene model for underground coal mines.

(3) By utilizing UWB anchor nodes as information hubs and integrating the constructed colored mesh map, the pose transmission of the master robot i and sub-robots within the UWB ranging range is realized, ultimately enabling the stitching of local colored mesh maps into a global colored mesh map.

The following detailed description of the technical solution of the present invention is provided with reference to the accompanying drawings and embodiments.

### BRIEF DESCRIPTION OF THE DRAWINGS

FIG. 1 is a system block diagram of the structure of the digital twin scene construction system in the embodiment of the underground multirobot collaborative digital twin scene model construction system and method of the present invention.

FIG. 2 is a schematic diagram of the structure of the master robot i in the embodiment of the underground multirobot collaborative digital twin scene model construction system and method of the present invention.

FIG. 3 is a topology diagram of the underground multirobot collaboration in the embodiment of the underground multirobot collaborative digital twin scene model construction system and method of the present invention.

FIG. 4 is a flowchart of the underground multirobot scene construction method in the embodiment of the underground multirobot collaborative digital twin scene model construction system and method of the present invention.

FIG. 5 is a factor graph optimization diagram for underground multisensor fusion in the embodiment of the underground multirobot collaborative digital twin scene model construction system and method of the present invention.

FIG. 6 is a diagram of the underground colored mesh map construction in the embodiment of the underground multirobot collaborative digital twin scene model construction system and method of the present invention.

FIG. 7 is a diagram of the underground multirobot path planning and obstacle avoidance in the embodiment of the underground multirobot collaborative digital twin scene model construction system and method of the present invention.

FIG. 8 is a diagram of multirobot collaborative mapping and localization in the embodiment of the underground multirobot collaborative digital twin scene model construction system and method of the present invention.

FIG. 9 is a diagram of the multirobot transformation matrix estimation in the embodiment of the underground multirobot collaborative digital twin scene model construction system and method of the present invention.

### REFERENCE NUMERALS IN THE FIGURES

1. UWB anchor node;

2. LiDAR feature point;

3. Visual feature point;

4. LiDAR observation;

5. Visual observation;

6. UWB observation;

7. IMU observation;

21. Intrinsically safe LiDAR;

22. Intrinsically safe camera;

23. Ultra-wideband ranging unit;

24. Inertial measurement unit;

25. Mesh node;

26. WiFi base station;

27. Visualization module;

28. Explosionproof box;

29. Fixed bracket;

30. Tracked chassis;

31. Master robot i;

32. Subrobot j;

33. Subrobot r;

34. Master robot i UWB mobile node;

35. Subrobot j UWB mobile node;

36. Subrobot r UWB mobile node;

51. State quantity;

52. LiDAR odometry factor;

53. Visual odometry factor;

54. UWB distance factor;

55. IMU preintegration factor;

56. UWB position factor;

57. IMU data;

61. Raw colored point cloud;

62. Colored point cloud after voxel grid division;

63. Point cloud after projection dimensionality reduction;

64. Triangular patches after Delaunay triangulation;

65. Updated colored mesh map;

71. Obstacle;

72. Triangle formation;

73. Straightline formation;

81. Current pose of master robot i;

82. Current pose of subrobot;

91. Anchor node A;

92. Circle I;

93. Circle II;

94. Circle III.

### DETAILED DESCRIPTION OF THE EMBODIMENTS

The following is a further explanation of the technical solutions of the present invention through the accompanying drawings and embodiments.

Unless otherwise defined, technical or scientific terms used in the present invention shall have the usual meaning as understood by a person skilled in the art to which the present invention pertains.

### Embodiment 1

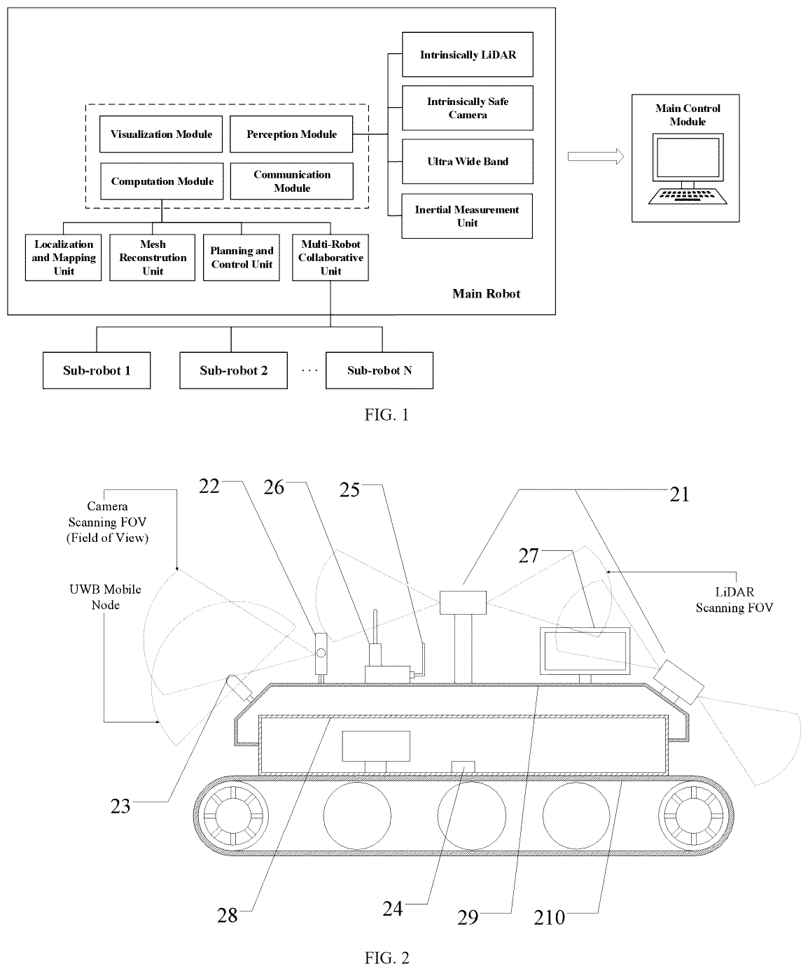

As shown in FIG. 1, the present invention provides an underground multi-robot collaborative digital twin scene model construction system, which includes a master robot i31 and sub-robots. Both the master robot i31 and the sub-robots are connected to the main control module. The master robot i31 is equipped with a visualization module 27, a perception module, a computing module, and a communication module.

Visualization module 27: Used for displaying the digital twin scene model, equipment model, monitoring the robot's motion state, battery level, wear condition, and monitoring the external environment's temperature and humidity.

Perception module: Used for the robot to sense features, temperature, and humidity in the underground coal mine. The perception module includes an intrinsically safe LiDAR 21, an intrinsically safe camera 22, an ultra-wideband ranging unit 23, and an inertial measurement unit 24. The intrinsically safe LiDAR 21 is used to collect 3D point cloud data. The intrinsically safe camera 22 is used to observe the tunnel cross-section morphology and the positions between robots. The ultra-wideband ranging unit 23 is used to achieve wireless sensor network positioning and coordinate system alignment between multiple robots. The inertial measurement unit 24 is used to obtain attitude information.

The intrinsically safe LiDAR 21 uses the VLP-16 LiDAR produced by Velodyne, which retains the function of adjustable motor speed and can upload measurement values of surrounding distance and reflectivity in real time. The VLP-16 has a long-range measurement distance of 100 meters, weighs 830 g, and is suitable for installation on small drones and small mobile robots, outputting up to 300,000 points of data per second with a +15° vertical field of view and a 360° horizontal field of view scan.

The intrinsically safe camera 22 uses the RealSense D435i depth camera produced by Intel, which features an imager, IR projector, left imager, RGB module, and built-in IMU. The RealSense D435i is low-cost, lightweight, and powerful, with a shooting range of up to 10 meters, easily integrated into various platforms, and provides cross-platform support.

The ultra-wideband ranging unit 23 of the present invention uses the P440 module produced by Time Domain in the U.S. The P440 module is an ultra-wideband transceiver with a frequency band between 3.1 GHZ and 4.8 GHz. It is a coherent transceiver, meaning that the energy of each transmitted pulse can be added to increase the signal-to-noise ratio (SNR) of the received signal. The P440 primarily uses the two-way time-of-flight method to measure distance between two or more modules, with a refresh rate of up to 125 Hz, enabling communication between two or more modules. It features a networked distance measurement function optimized for two-way time-of-flight distance measurement, with networked distance measurement supporting ALOHA (random) or TDMA (time division multiple access) protocols, with measurement accuracy reaching 10 cm and minimal transmission power. It can perform four functions simultaneously (ranging, data transmission, single-base LiDAR, and multi-base LiDAR). The present invention mainly uses three of these functions: single-point ranging, data transmission, and multi-base LiDAR.

For the intrinsically safe inertial measurement unit 24, the present invention uses the MTi-G710 inertial measurement unit produced by Xsens Technology in the Netherlands. This is an industrial-grade IMU based on miniature inertial sensing technology. This sensor can publish raw angular velocity and linear acceleration information at a frequency of 1000 Hz. It uses a USB 3.0 interface to directly transmit sensor information to the computing module for processing.

Computing module: Used to process data related to the movement, positioning, mapping, exploration, and path planning of single/multiple underground robots. The computing module includes a positioning and mapping unit, a mesh reconstruction unit, a planning control unit, and a multi-machine collaboration unit, which is connected to the sub-robots. The positioning and mapping unit, mesh reconstruction unit, and planning control unit are used for SLAM positioning and colored point cloud construction, mesh map construction, motion control, and path planning for a single robot. Multi-robot collaborative unit enables collaborative positioning and mapping, planning control, mesh reconstruction, and cluster exploration between the master robot i and the sub-robots.

Communication module: Used for communication between multiple underground robots and between the underground environment and the ground.

The structure of the master robot i31 is the same as that of the sub-robots. As shown in FIG. 2, it includes a tracked chassis 210. The tracked chassis 210 facilitates the movement of the master robot i31 and the sub-robots. A flameproof box 28 is installed on top of the tracked chassis 210, housing the inertial measurement unit 24 and the computing module. The flameproof box 28 provides protection for the inertial measurement unit 24 and the computing module. A fixed bracket 29 is installed on top of the flameproof box 28, providing support for other structures.

One side of the top of the fixed bracket 29 is equipped with the ultra-wideband ranging unit 23. The ultra-wideband ranging unit 23 is divided into anchor nodes and mobile nodes. The mobile nodes are installed on the fixed brackets 29 of each robot, and the number and location of the anchor nodes depend on the complexity of the environment. One side of the ultra-wideband ranging unit 23 is equipped with the intrinsically safe camera 22, which is a depth camera. The number of intrinsically safe cameras 22 is deployed according to actual needs. The intrinsically safe camera 22 is used to identify the distance between robots and the structured environment of the tunnel. A WiFi base station 26 is installed on one side of the intrinsically safe camera 22. The main control module controls the active robot through the WiFi base station 26. A Mesh node 25 is installed on the WiFi base station 26. The master robot i31 controls the sub-robots through the Mesh node 25.

Two intrinsically safe LiDARs 21 are installed on one side of the WiFi base station 26, with one mounted at a horizontal direction and another at a 45-degree angle for each robot. The intrinsically safe LiDARs 21 collect point cloud data of the tunnel cross-section during movement. Between the two intrinsically safe LiDARs 21 is the visualization module 27, which is a display screen used to visualize the tunnel model, sensor data, digital twin device model, and scene model.

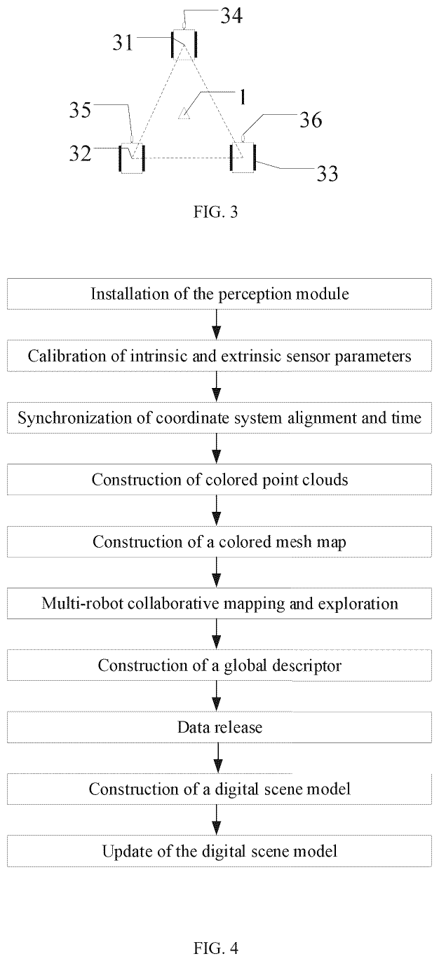

Multi-robot collaborative unit adopts a centralized robot swarm structure. As shown in FIG. 3, the structure is divided into a master robot i31 and sub-robots. The sub-robots include sub-robot j32 and sub-robot r33. The master robot i31 is responsible for processing all the positioning information, mapping information, and environmental information collected by sub-robot j32, sub-robot r33, and itself. Sub-robot j32 and sub-robot r33 operate under the instructions issued by the master robot i31.

After all the sub-robots complete mapping and positioning, they transmit the mapping and positioning information to the master robot i31's computing module. The master robot i31 completes the fusion of the maps transmitted from sub-robot j32 and sub-robot r33. Finally, the master robot i31, as the center of the robot swarm, completes planning control, scene recognition, and collaborative exploration. Within the UWB anchor node 1's ranging range, data exchange and coordinate system conversion can be completed between multiple robots relative to the anchor node, thus converting the pose of the sub-robots to the master robot i31 and completing the coordinate system alignment.

A method for constructing an underground multi-robot collaborative digital twin scene model, as shown in FIG. 4, includes the following steps:

S1: Perception module installation. According to the tunnel length and cross-section, install the perception module and debug the position and direction of the intrinsically safe LiDAR 21, intrinsically safe camera 22, inertial measurement unit 24, and ultra-wideband ranging unit 23.

S2: Calibration of intrinsic and extrinsic parameters of the sensors. Obtain the distortion correction parameters of the intrinsically safe LiDAR 21, the intrinsic parameters of the intrinsically safe camera 22, the bias of the inertial measurement unit 24, and the correction coefficient of the ultra-wideband ranging unit 23. Calculate the extrinsic parameters transformation from the intrinsically safe LiDAR 21 to the inertial measurement unit 24, the extrinsic parameters transformation from the visual camera to the inertial measurement unit 24, and the extrinsic parameters transformation from the UWB mobile node to the UWB anchor node 1.

S3: Coordinate system alignment and time synchronization. Connect the perception module to the computing module through a USB port to complete the coordinate system alignment and time synchronization of the intrinsically safe LiDAR 21, intrinsically safe camera 22, and ultra-wideband ranging unit 23.

S4: Colored point cloud construction. Using the intrinsically safe LiDAR 21, intrinsically safe camera 22, inertial measurement unit 24, and UWB mobile node, complete high-precision colored point cloud construction based on graph optimization methods and calculate the six-degree-of-freedom pose of the robot, achieving precise positioning of the robot in the underground coal mine.

The process for constructing the color point cloud, as shown in FIG. 5, involves the following steps:

S4.1 Data Collection: The main control module remotely operates the master robot i31 via WiFi. The master robot i31, through Mesh node 25, controls the sub-robots j32 and r33 to repetitively collect tunnel data, including 3D point clouds, images, angular velocity, acceleration, gyroscope bias, accelerometer bias, ultra-wideband (UWB) distance, and UWB position information. Each robot uses a Robot Operating System (ROS) to record datasets, completing the tunnel data collection.

S4.2 Robot Motion Model Construction: A motion model is built for the robots, which includes their position, orientation, velocity, accelerometer and gyroscope biases, gravity direction, and the extrinsic calibration between the IMU24 and camera23.

S4.3 State Propagation: The motion model is discretized using an extended Kalman filter (EKF) with error iteration, constructing motion propagation equations and the covariance matrix.

S4.4 Sensor Observation Model Construction: The distance between the moving nodes (master robot i31, sub-robot j32 UWB node35, and sub-robot r33 UWB node36) and the UWB anchor nodel is calculated. UWB distance and position observations are built, LiDAR feature points2 are extracted, and LiDAR point-plane, point-line, and line-line observations are constructed. Additionally, the RGB information and inverse depth of visual feature points3 are calculated to build visual observations5. IMU data57 for angular velocity and acceleration are used to build IMU observations7. UWB observations6 serve three purposes: positioning, distance measurement, and data association. UWB positioning uses the TW_TOF method with four UWB anchor nodes1. UWB distance measurement uses the TOF method to calculate the time intervals between transmitting and receiving waves for distance measurement, requiring one anchor node. UWB data association calculates the transformation matrix between robots using triangulation.

S4.5 Factor Graph Optimization Model Construction: The factor graph consists of variable nodes representing system states and four types of factor nodes representing measurement constraints: IMU pre-integration factors55, LiDAR odometry factors52, visual odometry factors53, UWB distance factors54, and UWB position factors56. IMU pre-integration, UWB distance, and UWB position factors are represented by binary edges for relative constraints, while LiDAR and visual odometry factors are absolute measurement constraints represented by unary edges. The backend optimization module uses these factors to build a multi-sensor factor graph, obtaining optimal state estimation parameters through incremental smoothing optimization.

S4.6 LiDAR-Inertial Odometry Subsystem Construction: Based on the factor graph optimization model, the raw point cloud and IMU data57 collected in S4.1 are fused for state propagation in S4.3. The system state is estimated by minimizing the residual between LiDAR feature points2 and local map planes. Once the state converges, LiDAR feature points2 are added to the global map, marked as activated or deactivated, and form a geometric structure in the global map. These points provide depth and RGB information for the visual-inertial odometry subsystem.

S4.7 Visual-Inertial Odometry Subsystem Construction: The visual-inertial odometry subsystem is built by projecting map points from the global map in S4.6 onto the current image. System state is estimated by minimizing the reprojection error between frames, using the factor graph optimization model. The state estimate is further optimized by minimizing the photometric error between tracked map points and the current frame.

S4.8 Factor Graph Optimization: After constructing the factor graph, the optimization process solves for the optimal system states by ensuring UWB, LiDAR, visual, and IMU measurements reach optimality, resulting in the best system state estimates51.

To ensure the system's real-time requirements, a fixed-length sliding window is used during joint optimization. When the number of system state frames within the sliding window exceeds a threshold, historical frames are marginalized, and a new sliding window is set. Since a system state node in the factor graph is only connected to three or four types of constraint factors, the overall factor graph is relatively sparse. To ensure sufficient measurement constraints for accurate system state estimation while maintaining real-time requirements, a sliding window containing 30 state nodes is used during factor graph optimization.

S4.9 Global Map Texture Rendering: Following updates from the visual-inertial odometry subsystem in S4.7, the pose of the current frame is refined, and the map point colors are updated. This involves retrieving active voxel points, applying linear interpolation for RGB values, and performing Bayesian updates to fuse new and existing colors.

S4.9.1. Retrieve all points from all activated voxels. If these points fall within the current image, use linear interpolation on the current frame image to obtain the RGB color values of adjacent pixels, resulting in the color and covariance for each map point;

S4.9.2. Through Bayesian updating, merge the colors of newly observed points on the image with the existing color values recorded in the map to obtain updated color values and covariance.

S4.10. Construction of Colored Point Cloud Map: First, after texture rendering in S4.9, update the tracked map point set. If the reprojection or photometric error in S4.7 is too large, remove the map points from the point set and also discard points that do not belong to the current image frame. Second, project each point in the tracked map point set onto the current image. If there are no other tracked points nearby (e.g., within a radius of 50 pixels), add it to the tracked map point set. Finally, the colored point cloud is constructed from the global map obtained through color rendering in S4.9, and the optimal estimation of the system state is completed in S4.8.

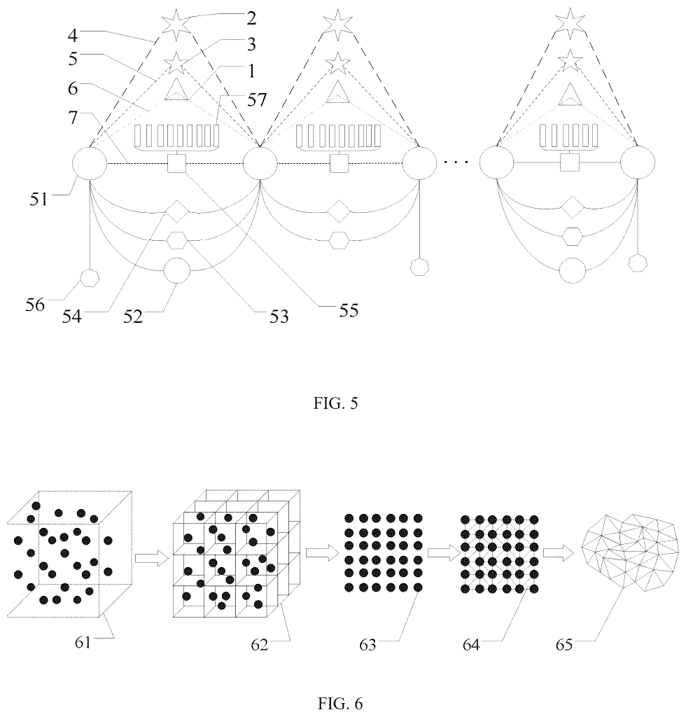

S5 Colored Mesh Map Construction: The steps for constructing the colored mesh map, shown in FIG. 6, include:

S5.1 Colored Point Cloud Import: Import the colored point cloud61 from S4.10 into the mesh reconstruction unit for further processing.

S5.2 Point Cloud Preprocessing: Filter, downsample, and remove noise from the colored point cloud61.

S5.3 Voxel-Based Vertex Retrieval and Expansion: Subdivide the point cloud into voxels, retrieve vertices for mesh reconstruction, and perform 3D point cloud dilation to improve triangle mesh quality.

S5.4 Projection and Dimensionality Reduction: Project the 3D vertices onto a 2D plane, resulting in a reduced-dimensional point cloud63.

S5.5 2D Delaunay Triangulation: Triangulate the point cloud 63 into irregular triangles, resulting in Delaunay triangulation.

S5.6 Colored Mesh Map Construction: Incrementally update the triangle mesh and integrate it into the voxel map, involving vertex retrieval, incremental mesh updates, and mesh insertion.

S6 Multi-Robot Collaborative Exploration and Mapping: UWB anchor node 1 serves as the information hub. With the optimal state estimation from S4 and the colored mesh map from S5, collaborative robot formation control, path planning, and map fusion are achieved.

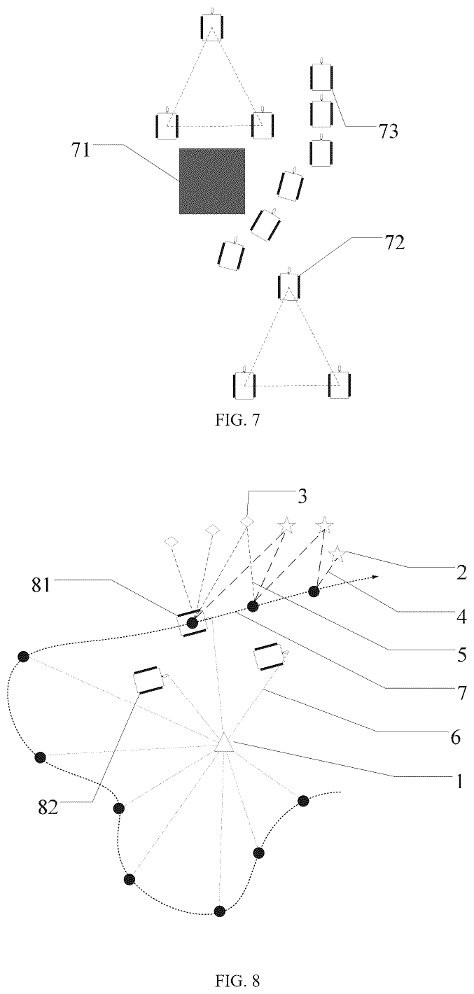

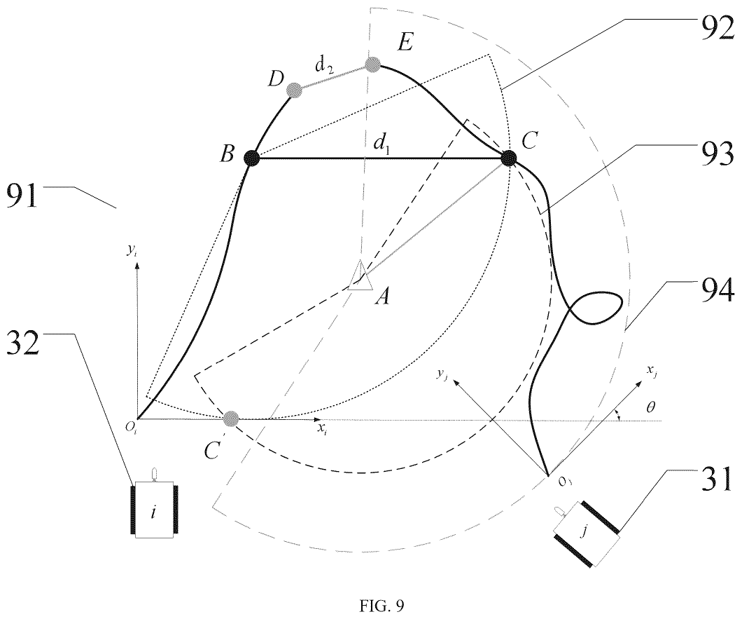

As shown in FIGS. 7 and 8, the multi-robot collaborative exploration and mapping specifically include the following steps:

S6.1 Multi-Robot Deployment: Deploy the master robot i31, the sub-robot j32, and the sub-robot r33 to specified locations in the tunnel. Complete the installation of the perception modules, calibration of intrinsic and extrinsic parameters, alignment of coordinate systems, and time synchronization according to steps S5.1 to S5.3. Additionally, ensure that the time synchronization and wireless Mesh node 25 communication frequency of the computing modules for the master robot i31, sub-robot j32, and sub-robot r33 are consistent.

S6.2 Multi-Robot Collaborative Path Planning: The master robot i31 uses a global path planning algorithm based on A* to search for an optimal global path from the starting point to the target point, based on its positioning information and map information obtained in S4.8 and S4.10. At the same time, the master robot i31 uses a local path planning algorithm based on DWA to adjust the poses of the sub-robot j32 and the sub-robot r33 by calculating the distances to obstacles 71, enabling the sub-robots to avoid obstacles 71, and ultimately planning the multi-robot path to ensure that the robot formation reaches the target point smoothly.

S6.3 Multi-Robot Formation Control and Obstacle Avoidance: Construct a multi-robot formation movement model. The master robot i31 performs global and local path planning to achieve autonomous navigation, while the sub-robots j32 and r33 measure distances to obstacles 71 while following the master robot i31. When the sub-robots j32 and r33 are far from obstacle 71, the robot group maintains a triangular formation 72. When they are close to obstacle 71, the master robot i31 recalculates the poses of the sub-robots j32 and r33, and the robot group adjusts to a line formation 73 to avoid obstacle 71. When the sub-robots j32 and r33 are again far from obstacle 71, the master robot i31 adjusts their poses back to the original state, maintaining the triangular formation 72. This ultimately allows the robots to maintain a fixed formation while planning paths and avoiding obstacles 71.

S6.4 Multi-Robot UWB Distance Measurement and Data Exchange: When multiple robots enter the measurement range of a UWB anchor node 1, they use UWB for distance measurement and exchange the current poses 81 of the master robot i and the poses 82 of the sub-robots, as well as the anchor positions. After receiving two distance measurements and data exchanges, calculate the transformation matrix between the master robot i31 and the sub-robots using the triangle principle and input the transformation matrix into the master robot i31.

The relative pose transformation method between robots is: In the presence of common anchors, the transformation between robots is estimated directly when robots converge. Robots only need to send their current positions and anchor positions when measuring distances to neighboring robots. After receiving the information, robots calculate the transformation matrix between themselves and the sender. Once the transformation matrix is accurately estimated, all information received from neighboring robots is correctly placed in the robot's coordinate system. For the master robot i and the sub-robot j, denote the transformation matrix from the master robot i to the sub-robot j as

$${T}_{i}^{j} = [ {R}_{i}^{j} , {t}_{i}^{j} ] ,$$

where

$${R}_{i}^{j}$$

represents a 3×3 matrix for rotation and

$${t}_{i}^{j}$$

represents a 3×1 vector for translation. Using accelerometers and gyroscopes, determine the direction of gravity and define a common z-axis for all robots. During coordinate system creation, align the z-axis opposite to the direction of gravity. Estimate the yaw angle 0 and translation vector

$${t}_{i}^{j}$$

between the two coordinate systems. The transformation matrix

$${T}_{i}^{j}$$

includes:

$${R}_{i}^{j} = [ \begin{matrix}cos ( θ ) & - sin ( θ ) & 0 \\ sin ( θ ) & cos ( θ ) & 0 \\ 0 & 0 & 1\end{matrix} ] , {t}_{i}^{j} = [ \begin{matrix}{t}_{x} \\ {t}_{y} \\ {t}_{z}\end{matrix} ]$$

Using the anchor positions of the two robots, estimate the projection of the difference vector between the master robot i and the sub-robot j on the z-axis,

$${t}_{z} = ( {P}_{A}^{jw} - {P}_{A}^{iw} ) z ,$$

leaving three parameters (θ, tₓ, t_{y}) to be estimated. The method for solving these three parameters includes the following steps:

S6.4.1 Exchange of Robot and Anchor Node Positions: Assume the master robot i and sub-robot j move independently in a two-dimensional space. Both robots have their own coordinate systems oᵢxᵢvᵢ and oⱼxⱼyⱼ and anchor A 91 positions. After initialization, each robot tracks its trajectory in its own coordinate system. When the master robot i passes point B and the sub-robot j passes point C and enters communication range, they obtain a bidirectional distance measurement d₁ and exchange their current positions and anchor A 91 positions in their respective coordinate systems oᵢxᵢyᵢ and oⱼxⱼyⱼ, obtaining

$${p}_{B}^{i} , {p}_{A}^{i} , {p}_{A}^{j} , {p}_{C}^{j} ,$$

where

$${p}_{B}^{i} , {p}_{A}^{i}$$

are the positions of points A and B in the master robot i's system, and

$${p}_{A}^{j} , {p}_{C}^{j}$$

are the positions of points A and C in the sub-robot j's system.

S6.4.2 Solving for the Coordinates of Sub-Robot Position C in the Master robot Coordinate System: From the perspective of the master robot i, when it receives the positions of anchor A 91 and sub-robot j's current position point C in the coordinate system oⱼxⱼyⱼ denoted as

$${p}_{A}^{i} and {p}_{C}^{i} ,$$

respectively, the master robot i knows that the origin of oⱼxⱼyⱼ must lie on a circle III 94 centered at anchor A 91 with radius |AOⱼ|. Additionally, the master robot i calculates circle II with radius |AC| to find that point C must lie on the circle centered at A with radius |AC|. The distance between points B and C is the measured range d₁, and point C must also lie on a circle I with radius d₁ centered at point B. By solving the following equation:

$$\{ \begin{matrix}{d}_{1} = ‖ {P}_{B}^{i} - {P}_{C}^{i} ‖ \\ \vert AC \vert = ‖ {P}_{A}^{j} - {P}_{C}^{j} ‖ \\ \vert AC \vert = ‖ {P}_{A}^{i} - {P}_{C}^{i} ‖\end{matrix}$$

we obtain the coordinates of point C in the master robot i's coordinate system.

S6.4.3 Solving for the Coordinates of Master robot Position B in Sub-Robot j's Coordinate System: When the sub-robot j receives the positions of anchor A 91 and the master robot i's current position point B in the coordinate system, denoted as

$${P}_{A}^{j} and {P}_{B}^{i} ,$$

respectively, the sub-robot j knows that the origin of oᵢxᵢyᵢ must lie on a circle centered at anchor A 91 with radius |AOᵢ|. Additionally, the sub-robot j calculates that point B must lie on a circle centered at A with radius |AB|. The distance between points B and C is the measured range d₁, and point B must also lie on a circle centered at point C with radius d₁. By solving the following equation:

$$\{ \begin{matrix}{d}_{1} = ‖ {P}_{B}^{j} - {P}_{C}^{j} ‖ \\ \vert AB \vert = ‖ {P}_{A}^{i} - {P}_{B}^{i} ‖ \\ \vert AB \vert = ‖ {P}_{A}^{j} - {P}_{B}^{j} ‖\end{matrix}$$

we obtain the coordinates of point B in the sub-robot j's coordinate system.

S6.4.4 Solving for Coordinates of D and E in Sub-Robot and Master robot Coordinate Systems: When the master robot i is at point B and the sub-robot j is at position P_{B}ⁱ in the master robot i's coordinate system, to further determine the positions of sub-robot j and master robot i in each other's coordinate systems, additional measurements d₂ between two subsequent points D and E are taken. Repeat steps S6.4.2 and S6.4.3, and solve the following equation:

$$\{ \begin{matrix}{d}_{2} = ‖ {P}_{D}^{j} - {P}_{E}^{j} ‖ \\ \vert AD \vert = ‖ {P}_{A}^{i} - {P}_{D}^{i} ‖ \\ \vert AD \vert = ‖ {P}_{A}^{j} - {P}_{D}^{j} ‖\end{matrix} , \{ \begin{matrix}{d}_{2} = ‖ {P}_{D}^{i} - {P}_{E}^{i} ‖ \\ \vert AE \vert = ‖ {P}_{A}^{i} - {P}_{E}^{i} ‖ \\ \vert AE \vert = ‖ {P}_{A}^{j} - {P}_{E}^{j} ‖\end{matrix}$$

to obtain the positions of point D in the sub-robot j's system and point E in the master robot i's system.

S6.4.5 Solving Robot Poses: Using the results from S6.4.2 to S6.4.4, obtain the positions of point B in the sub-robot j's system, point C in the master robot i's system, point D in the sub-robot j's system, and point E in the master robot i's system. Finally, solve the following equation:

$$\{ \begin{matrix}{P}_{A}^{j} = {T}_{i}^{j} \cdot {P}_{A}^{i} \\ {d}_{1} = ‖ {P}_{B}^{j} - {T}_{i}^{j} \cdot {P}_{C}^{i} ‖ \\ {d}_{2} = ‖ {P}_{D}^{j} - {T}_{i}^{j} \cdot {P}_{E}^{i} ‖\end{matrix}$$

to obtain the translation and rotation between the master robot i and the sub-robot j.

S6.5 Multi-Robot Colored Mesh Map Fusion: During map construction, each robot builds a local map starting from its initial point as the map origin. The map fusion strategy is based on coordinate transformations between local maps. Designate the coordinate system of the master robot i31's inertial measurement unit 24 as the reference coordinate system. Using the transformation matrices obtained in S6.4, transform the local maps created by the sub-robot j32 and the sub-robot r33 into the coordinate system of the master robot i31. Since the coordinate system of the master robot i31 coincides with the fused map coordinate system, directly store the local map of the master robot i31 and the transformed maps of the sub-robot j32 and sub-robot r33 into a newly defined point cloud map as the global color mesh map 65.

S7. Global Descriptor Construction: Construct a triangular descriptor, which is a global descriptor composed of three keypoint encodings extracted from the point cloud keyframes. It describes the relative distribution of keypoints within the keyframe. The triangular descriptor encodes any three keypoints in the scene using a triangle. The shape of the triangle is uniquely determined by its edge lengths or angles. Compared to local descriptors around keypoints, the shape of the triangle is completely invariant to rotation and translation. After constructing the triangular descriptor, location recognition is achieved by matching edge lengths between descriptors from different point clouds. The point correspondences obtained from descriptor matches can further be used for geometric verification, improving the accuracy of digital twin scene updates.

S8. Data Publishing: Process the colored point cloud and colored mesh point cloud data in parallel. After generating the colored point cloud, continuously input it into the mesh reconstruction unit for processing, ultimately generating a colored mesh map online. Implement multi-robot pose estimation and multi-robot map fusion in parallel, with sub-robots j32 and r33 continuously sending local maps and pose results to the master robot i31's computing module. The master robot i31's computing module concurrently optimizes the optimal pose of the robot group and integrates the local maps of sub-robots j32 and r33 with the master robot i31's map, enhancing the efficiency of the multi-robot collaborative mapping system.

S9. Digital Twin Scene Model Construction: Import the global colored mesh map 65 from S5.6 into the main control module. The main control module processes and analyzes the colored mesh map using Unity3D to construct a digital twin scene model of the underground coal mine.

S10. Digital Twin Scene Model Update: During the repetitive modeling process in the tunnel, use the global descriptors constructed in S7 for region detection. If the original descriptor at a particular location in the tunnel does not match the newly modeled descriptor, the scene is marked as an update area; otherwise, it is marked as a retained area. Then, the main control module directs the robots to map the area and updates the global colored mesh map with the obtained local colored mesh maps 65, completing the digital twin scene update.

Therefore, the present invention employs the aforementioned system and method for constructing a multi-robot collaborative digital twin scene model underground. This enables precise measurement and modeling of the geometric and physical structures of the tunnel, constructs a colored mesh map, and further imports the colored mesh map into Unity3D. It achieves pose transmission between the main robot i and the sub-robots within the UWB ranging range, ultimately merging the local colored mesh maps into a global colored mesh map, thereby realizing the construction of a digital twin scene model for large-scale underground coal mines.

It should be noted that the above embodiments are intended to illustrate the technical solutions of the invention and are not intended to limit them. Although the invention has been described in detail with reference to preferred embodiments, those skilled in the art should understand that modifications or equivalent replacements can be made to the technical solutions of the invention without departing from the spirit and scope of the invention.

1. A method for constructing a digital twin scene model for underground multi-robot collaboration, comprising the following steps:
S1. Perception Module Installation: install a perception module on a robot based on a length and cross-section of a tunnel;
S2. Intrinsic and Extrinsic Parameters Calibration: obtain distortion correction parameters of an intrinsically safe LiDAR, intrinsic parameters of an intrinsically safe camera, bias of an inertial measurement unit (IMU), and correction coefficients of an ultra-wideband (UWB) ranging unit; determine an extrinsic parameter from the intrinsically safe LiDAR to the IMU, from a visual camera to the IMU, and from UWB mobile nodes to UWB anchor nodes;
S3. Coordinate System Alignment and Time Synchronization: connect a perception module to a computing module via USB, completing coordinate system alignment and time synchronization for the intrinsically safe LiDAR, the intrinsically safe camera, and the UWB ranging unit;
S4. Colored Point Cloud Construction: utilize the intrinsically safe LiDAR, the intrinsically safe camera, the IMU, and the UWB mobile nodes to complete high-precision colored point cloud construction and calculate a six-degree-of-freedom pose of the robot based on graph optimization;
S4.1. Data Acquisition: remotely control, by a main control module, a main robot i via WiFi, wherein the main robot i uses Mesh nodes to control sub-robots to reciprocally collect tunnel point cloud data, IMU angular velocity and linear acceleration data, visual image data, and UWB ranging information data;
S4.2. Robot Motion Model Construction: construct a motion model of the main robot i and the sub-robots;
S4.3. State Propagation: utilize an error-state iterative extended kalman filter method to discretize the motion model and construct a motion propagation equation and a covariance matrix;
S4.4. Sensor Observation Model Construction: calculate a distance between the UWB mobile nodes and the UWB anchor nodes, construct UWB distance and position observation equations, and measure a distance through a direct calculation of a time interval between emitted and received waves; extract LiDAR feature points to construct LiDAR point-plane, point-line, and line-line observations; calculate RGB information and pixel inverse depth of feature points to construct visual observations, and estimate a current state by minimizing a photometric error between observed RGB colors of map points and measured colors of the map points in a current image; calculate an angular velocity and an acceleration of the IMU to construct IMU observations; wherein a UWB distance and position observation is used for UWB positioning, a UWB distance measurement and a UWB data association, the UWB positioning uses a two way time of flight (TW_TOF) method with four UWB anchor nodes, the UWB distance measurement uses a time of flight (TOF) method with one UWB anchor node, and the UWB data association calculates a transformation matrix between the main robot i and the sub-robots using triangulation;
S4.5. Construct Factor Graph Optimization Model: form a factor graph by variable nodes representing a system state and four types of factor nodes representing measurement constraints; wherein these five types of factor nodes provide different measurement constraints for system's state estimation; utilize the above five factors to construct a multi-sensor factor graph and obtains optimal state estimation parameters through incremental smoothing optimization;
S4.6. LiDAR Inertial Odometry Subsystem Construction: based on the S4.5 factor graph optimization model, fuse raw point cloud and IMU data collected in S4.1 to perform state propagation in S4.3, minimizing residuals from the LiDAR feature points to planes to estimate the system state, which is then added to a global map under convergent conditions, marking a voxel corresponding to the LiDAR feature point's location as active or inactive;
S4.7. Visual Inertial Odometry Subsystem Construction: use frame-to-frame optical flow to track the map points, estimate the system state using the factor graph optimization model, and further optimize the system state estimation by minimizing the photometric error between tracked map points and the global map;
S4.8. Factor Graph Optimization: once the factor graph is established, solve for an optimal set of system states that optimize all edges in the factor graph from S4.5, ultimately obtaining optimal system state quantities;
S4.9. Global Map Texture Rendering: after updating frame-to-map visual-inertial odometry subsystem in S4.7, obtain a precise pose of a current frame, and directly and effectively integrate visual data by minimizing the photometric error between the observed RGB colors of the map points and the measured colors of the map points in the current image, thereby updating the colors of the map points;
S4.10. Colored Point Cloud Map Construction: first, update a tracked map point set after texture rendering in S4.9, then project each point in the tracked map point set onto the current image, and finally construct a colored point cloud using the global map obtained from the color rendering in S4.9, completing an optimal estimation of the system state through S4.8;
S5. Colored Mesh Map Construction: based on the colored point cloud constructed in S4, build a colored mesh map using vertex retrieval, point projection dimensionality reduction, 2D Delaunay triangulation, and voxel grid partitioning;
S5.1. Import Colored Point Cloud Map: synchronize an original colored point cloud constructed in S4.10 into a mesh reconstruction unit of the computing module;
S5.2. Point Cloud Preprocessing: Perform filtering, down-sampling, and noise removal on the original colored point cloud obtained in S5.1;
S5.3. Voxel-Based Vertex Retrieval and Vertex Expansion: first, use hierarchical voxels to subdivide the original colored point cloud into many regions, retrieve vertices that need to be subdivided into the mesh with newly added points, then, execute 3D point cloud expansion to add mesh vertices and erode gaps between voxels, achieving higher quality triangular meshes;
S5.4. Projection Dimensionality Reduction: utilize the retrieved mesh vertices from S5.3 to project the 3D vertices onto a 2D plane, ultimately obtaining projected and dimensionally reduced point cloud;
S5.5. 2D Delaunay Triangulation: divide the projected and dimensionally reduced point cloud into uneven triangular meshes, obtaining triangular patches after Delaunay triangulation;
S5.6. Colored Mesh Map Construction: update triangular patches through voxel grid partitioning operations and newly constructed triangular surfaces from 2D Delaunay triangulation, gradually merging the mesh map into currently stored voxels in the map structure;
S6. Multi-Robot Collaborative Exploration and Mapping: utilize the UWB anchor nodes as a information hub, combining an optimal robot state estimation calculated in S4 with the colored mesh map constructed in S5 to achieve multi-robot coordinated formation control, path planning, and map integration;
S6.1. Multi-Robot Deployment: deploy the main robot i, sub-robot j, and sub-robot r to designated positions in the tunnel, completing installation of the perception module, intrinsic and extrinsic parameters calibration, coordinate system alignment, and time synchronization according to steps S5.1 to S5.3, as well as time synchronization of the computing module and consistency in a wireless Mesh node communication frequency;
S6.2. Multi-Robot Collaborative Path Planning: utilize, by the main robot i, an A*-based global path planning algorithm to search for a globally optimal path from a starting point to a target point based on localization and map information of the main robot i obtained in S4.8 and S4.10; wherein the main robot i then uses a DWA-based local path planning algorithm to adjust poses of sub-robots j and r by calculating their relative distances to obstacles;
S6.3. Multi-Robot Formation Control and Obstacle Avoidance: construct a following formation motion model for the multi-robots, wherein the main robot i performs global and local path planning for autonomous navigation, while the sub-robots j and r measure their relative distances to the obstacles while following the main robot i;
S6.4. Multi-Robot UWB Ranging and Data Exchange: when multiple robots enter a ranging area of a UWB anchor node, the multiple robots use UWB for ranging and exchanging current poses of the main robot i, sub-robots, and the anchor location;
wherein a relative pose transformation method for multi-robots is as follows: in the presence of common anchors, when robots converge, they directly estimate a transformation between the robots; each robot only needs to send its current position and the anchor location when measuring the distance to nearby robots; upon receiving this information, the robot calculates the a transformation matrix between itself and a sender;
once the transformation matrix is accurately estimated, all information received from nearby robots is correctly placed in the coordinate system of that robot;
for the master robot i and sub-robot j, the transformation matrix from the master robot i to the sub-robot j is denoted as
$${T}_{i}^{j} = [ {R}_{i}^{j} , {t}_{i}^{j} ] ,$$
where
$${R}_{i}^{j}$$
is a 3×3 matrix representing rotation, and
$${t}_{i}^{j}$$
is a 3×1 vector representing translation; using an accelerometer and a gyroscope, determine the gravity direction and define a same z-axis for all robots; when creating a coordinate system, align the z-axis opposite to the gravity direction; estimate a yaw angle θ and a translation vector between the two coordinate systems; the transformation matrix
$${T}_{i}^{j}$$
comprises:
$${R}_{i}^{j} = [ \begin{matrix}cos ( θ ) & - sin ( θ ) & 0 \\ sin ( θ ) & cos ( θ ) & 0 \\ 0 & 0 & 1\end{matrix} ] , {t}_{i}^{j} = [ \begin{matrix}{t}_{x} \\ {t}_{y} \\ {t}_{z}\end{matrix} ]$$
using the anchor positions of the two robots, estimate the projection of the difference vector between the master robot i and the sub-robot j onto the z-axis, denoted as
$${t}_{z} = ( {P}_{A}^{jw} - {P}_{A}^{iw} ) z ;$$
the three parameters (θ, tₓ, t_{y}) to be estimated are solved as follows:
S6.4.1, Exchange of Robot and Anchor Node Positions: assume that the master robot i and the sub-robot j move independently in a 2D space, both robots have their coordinate systems oᵢxᵢyᵢ and oⱼxⱼyⱼ, initial anchor A positions, and track their trajectories in their respective coordinate systems; when the master robot i passes point B and the sub-robot j passes point C, they enter a communication range and obtain a bidirectional distance measurement d₁; additionally, they exchange their current positions and anchor A positions in their respective coordinate systems oᵢxᵢyᵢ and oⱼxⱼyⱼ, obtaining:
$${p}_{B}^{i} , {p}_{A}^{i} , {p}_{A}^{j} , {p}_{C}^{j} ,$$
where
$${p}_{B}^{i} , {p}_{A}^{i}$$
are positions of points A and B in the coordinate system of the master robot i, and
$${p}_{A}^{j} , {p}_{C}^{j}$$
are positions of points A and C in the coordinate system of the sub-robot j;
S6.4.2, Solving Sub-Robot Position C in the Master Robot's Coordinate System: from the perspective of the master robot i, when it receives the position of anchor A and the current position of sub-robot j's point C in the coordinate system oⱼxⱼyⱼ, i.e.,
$${p}_{A}^{i} , {p}_{C}^{j} ,$$
it knows that the origin of oⱼxⱼyⱼ must be located on a circle III centered at A with radius |AOⱼ|; furthermore, the master robot i calculates |AC| to find that sub-robot j's position C must be located on a circle II centered at A with radius |AC|; the distance between points B and C is measured as d₁, and point C must also be located on a circle I centered at B with radius d₁; by solving the following equations:
$$\{ \begin{matrix}{d}_{1} = ‖ {P}_{B}^{i} - {P}_{C}^{i} ‖ \\ \vert A C \vert = ‖ {P}_{A}^{j} - {P}_{C}^{j} ‖ \\ \vert A C \vert = ‖ {P}_{A}^{i} - {P}_{C}^{i} ‖\end{matrix}$$
obtain the position of point C in the coordinate system of the master robot i;
S6.4.3, Solving Master Robot Position B in the Sub-Robot's Coordinate System: when the sub-robot j receives the position of anchor A and the current position of the master robot i+s point B in the coordinate system, i.e.,
$${P}_{A}^{j} , {P}_{B}^{i} ,$$
it knows that an origin of oᵢxᵢyᵢ must be located on a circle centered at A with radius |AOᵢ|; additionally, the sub-robot robot j calculates |AB| to find that the master robot i's position B must be located on a circle centered at A with radius |AB|; the distance between points B and C is measured as d₁, and point B must also be located on a circle centered at C with radius d₁; by solving the following equations:
$$\{ \begin{matrix}{d}_{1} = ‖ {P}_{B}^{j} - {P}_{C}^{j} ‖ \\ \vert AB \vert = ‖ {P}_{A}^{i} - {P}_{B}^{i} ‖ \\ \vert AB \vert = ‖ {P}_{A}^{j} - {P}_{B}^{j} ‖\end{matrix}$$
obtain the position of point B in the coordinate system of the sub-robot j;
S6.4.4, Solving Coordinates of Points D and E in the Sub-Robot and Master Robot Systems: when the master robot i is at point B and sub-robot j is at its position in the coordinate system of the master robot i, to further determine the positions of the sub-robot j and the master robot i in each other's coordinate systems, perform additional measurements between two subsequent points D and E; repeat steps S6.4.2 and S6.4.3 to solve the following equations:
$$\{ \begin{matrix}{d}_{2} = ‖ {P}_{D}^{j} - {P}_{E}^{j} ‖ \\ \vert AD \vert = ‖ {P}_{A}^{i} - {P}_{D}^{i} ‖ \\ \vert AD \vert = ‖ {P}_{A}^{j} - {P}_{D}^{j} ‖\end{matrix} , \{ \begin{matrix}{d}_{2} = ‖ {P}_{D}^{i} - {P}_{E}^{i} ‖ \\ \vert AE \vert = ‖ {P}_{A}^{i} - {P}_{E}^{i} ‖ \\ \vert AE \vert = ‖ {P}_{A}^{j} - {P}_{E}^{j} ‖\end{matrix}$$
obtain the position of point D in the coordinate system of the sub-robot j and the position of point E in the coordinate system of the master robot i;
S6.4.5, Robot Pose Calculation: using the results obtained from steps S6.4.2 to S6.4.4,comprising the position of point B in the coordinate system of the sub-robot j, the position of point C in the coordinate system of the master robot i, the position of point D in the coordinate system of the sub-robot j, and the position of point E in the coordinate system of the master robot i, calculate the translation and rotation from the master robot i to the sub-robot j as follows:
$$\{ \begin{matrix}{P}_{A}^{j} = {T}_{i}^{j} \cdot {P}_{A}^{i} \\ {d}_{1} = ‖ {P}_{B}^{j} - {T}_{i}^{j} \cdot {P}_{C}^{i} ‖ \\ {d}_{2} = ‖ {P}_{D}^{j} - {T}_{i}^{j} \cdot {P}_{E}^{i} ‖\end{matrix}$$
S6.5. Multi-Robot Colored Mesh Map Fusion: during a mapping process of the multi-robot system, each robot constructs a local map using its respective starting point from a mapping algorithm as a map origin, and performs map fusion and stitching based on a coordinate transformations between local maps;
S7. Global Descriptor Construction: construct a triangular descriptor, then project the colored point cloud onto a plane boundary and extract key points, wherein adjacent key points form triangular descriptors; these descriptors are invariant to rotation and translation while maintaining high distinguishability;
S8. Data Publishing: processes, by the main robot i, the original colored point cloud calculated in S4.10 and the updated colored mesh map obtained in S5.6 through the computing module, and publishes odometry data at a sampling rate of the inertial measurement unit;
S9. Digital Twin Scene Model Construction: import the global colored mesh map from S5.6 into the main control module, wherein the main control module processes and analyzes the colored mesh map using Unity3D to construct the digital twin scene model for underground coal mines;
S10. Digital Twin Scene Model Update: during a back-and-forth modeling process of a robot group in the tunnel, utilize global descriptors constructed in S7 for area detection;
wherein when an original descriptor at a certain position in the tunnel does not match the newly modeled descriptor, the scene is marked as an update area; the main control module then directs the robot to map this area and updates the obtained local colored mesh map into the global colored mesh map, completing update of a digital twin scene.

2. The method for constructing the digital twin scene model for underground multi-robot collaboration according to claim 1, wherein in S7, the triangular descriptors are extracted from the point cloud keyframes and consist of encoded global descriptors formed by three key points, wherein the encoded global descriptors are configured to describe relative distribution of key points in the keyframe; the triangular descriptors encode any three key points in the scene, with a shape of the triangle uniquely determined by its side lengths or angles; compared to local descriptors around key points, the shape of the triangle is entirely invariant to rotation and translation; after constructing the triangular descriptors, location recognition is achieved by matching the side lengths of descriptors between point clouds, and the point correspondences obtained from descriptor matching are further used for geometric verification.

3. The method for constructing the digital twin scene model for underground multi-robot collaboration according to claim 1, wherein the specific operation in S8 involves processing colored point cloud and colored mesh point cloud data in parallel;
after generating the colored point cloud, it is continuously fed into the mesh reconstruction unit for processing, ultimately generating the colored mesh map online; the method also implements parallel estimation of the poses of multiple robots and fusion of maps during the collaborative mapping process, wherein sub-robots continuously send local map and pose results to the computing module of the main robot i, and the main robot i optimizes the optimal poses of the robot group and fuses the local maps of sub-robots and the main robot i in parallel.

4. A system for the method for constructing the digital twin scene model for underground multi-robot collaboration according to claim 1, comprising the main robot i and sub-robots, wherein both the main robot i and the sub-robots are connected to the main control module; the main robot i is equipped with a visualization module, a perception module, a computing module, and a communication module;
the visualization module is used to display the digital twin scene model, equipment model, monitor robot motion status, battery level, wear condition, and external environment temperature and humidity;
the perception module is used for the main robot i and the sub-robots to perceive features, temperature, and humidity in an underground coal mine;
the computing module is used to process data for single and multi-robot movement, localization, mapping, exploration, and path planning;
the communication module is used for communication between multiple robots underground and between underground and ground;
wherein the perception module comprises the intrinsically safe LiDAR, the intrinsically safe camera, the UWB ranging unit, and the inertial measurement unit:
wherein the computing module comprises a localization and mapping unit, a mesh reconstruction unit, a planning and control unit, and a multi-robot collaborative unit, wherein the multi-robot collaborative unit is connected to the sub-robots, and the sub-robots comprise the sub-robot j and the sub-robot r; the main robot i has a same structure as the sub-robots, featuring a tracked chassis; a top of the tracked chassis is equipped with an explosion-proof enclosure, and the explosion-proof enclosure houses the inertial measurement unit and the computing module; a top of the explosion-proof enclosure has a fixed bracket, with the UWB ranging unit mounted on one side of the fixed bracket, the intrinsically safe camera on the other side; a WiFi base station is mounted next to the intrinsically safe camera; the WiFi base station is equipped with the Mesh nodes; and two intrinsically safe LiDARs are mounted on a side of the WiFi base station, and the visualization module is positioned between the two intrinsically safe LiDARs.

5. The system according to claim 4, wherein in S7, the triangular descriptors are extracted from the point cloud keyframes and consist of encoded global descriptors formed by three key points, wherein the encoded global descriptors are configured to describe relative distribution of key points in the keyframe; the triangular descriptors encode any three key points in the scene, with a shape of the triangle uniquely determined by its side lengths or angles; compared to local descriptors around key points, the shape of the triangle is entirely invariant to rotation and translation; after constructing the triangular descriptors, location recognition is achieved by matching the side lengths of descriptors between point clouds, and the point correspondences obtained from descriptor matching are further used for geometric verification.

6. The system according to claim 4, wherein the specific operation in S8 involves processing colored point cloud and colored mesh point cloud data in parallel; after generating the colored point cloud, it is continuously fed into the mesh reconstruction unit for processing, ultimately generating the colored mesh map online; the method also implements parallel estimation of the poses of multiple robots and fusion of maps during the collaborative mapping process, wherein sub-robots continuously send local map and pose results to the computing module of the main robot i, and the main robot i optimizes the optimal poses of the robot group and fuses the local maps of sub-robots and the main robot i in parallel.
